(19) United States
(12) Patent Application Publication
(10) Pub. No.: US 2026/0103618 A1
(43) Pub. Date: Apr. 16, 2026

(54) POLYMER DISPERSIONS WITH BALANCED SHEAR STABILITY AND THICKENER RESPONSE

(71) Applicant: Celanese International Corporation, Irving, TX (US)

(72) Inventors: Matthias Junk, Alsbach-Hähnlein (DE); Maximilian Nau, Mühltal (DE)

(73) Assignee: Celanese International Corporation, Irving, TX (US)

(21) Appl. No.: 19/346,936

(22) Filed: Oct. 1, 2025

Related U.S. Application Data
(60) Provisional application No. 63/706,137, filed on Oct. 11, 2024.

(51) Int. Cl. C09D 133/26; C08F 220/14; C09D 7/43; C09D 7/65

(52) U.S. Cl. CPC C09D 133/26; C08F 220/14; C09D 7/43; C09D 7/65; C08F 2800/20

(57) ABSTRACT

A coating composition (e.g., a paint) may include: a pigment; a filler; a polymer dispersion; and a thickener. The polymer dispersion may include a polymer produced by free-radically initiated emulsion polymerization of monomers including ethylenically unsaturated monomers. Said ethylenically unsaturated monomers may include 1.0 wt % to 2.0 wt % carboxylic acid-functional monomers and 1.0 wt % to 2.0 wt % sulfonic acid-functional monomers, each based on a total weight of the monomers, where a sum of the carboxylic acid-functional monomers and the sulfonic acid-functional monomers is 2.5 wt % to 3.5 wt %, based on a total weight of the monomers.

### CROSS-REFERENCE TO RELATED APPLICATIONS

This application claims priority to U.S. Provisional Patent Application No. 63/706,137, filed Oct. 11, 2024, the disclosure of which is incorporated herein by reference.

### FIELD OF THE INVENTION

The present invention relates generally to coating compositions containing polymer dispersions that exhibit excellent shear stability in the presence of fillers (allowing them to be used during production of the pigment paste) and thickener response (limiting the amount of thickeners in the coating compositions). Specifically, the polymer dispersion comprises a polymer formed by polymerization of monomers that include carboxylic acid-functional monomers and sulfonic acid-functional monomers at low concentrations.

### BACKGROUND OF THE INVENTION

Latex-based paints have captured a significant portion of the indoor and outdoor paint market as a result of the many advantages that such paints have over solvent-based products. The main advantages of latex-based paints include easy clean up, low odor, and fast dry.

The majority of latex-based paints are designed and marketed for either interior or exterior applications. Modern interior paints are usually formulated at a pigment volume concentration (PVC) above 60% (low binder content) and are optimized for high hiding power and good wet scrub resistance. They are usually ammonia-free and do not comprise any solvents or coalescent agents, that would account for odor and unwanted emissions. Exterior latex-based paints are much more binder-rich, optimized for good weather resistance and may still comprise a small amount of coalescent agents to enable good film formation at a higher glass transition temperature of the dispersion polymer.

As a niche application, so-called house paints are formulated and marketed as universal paints, both suited for interior and exterior application and equipped with good adhesion on a variety of substrates. These paints are binder-rich to exhibit good weather resistance, while being formulated without solvents and ammonia to meet the strict VOC (volatile organic content) and emission requirements of interior paints. Those paints pose challenging conditions for the employed polymer dispersions in terms of VOC requirements, adhesion profile, and other parameters. The high binder content of these paints often mandates the use of at least a part of the polymer dispersion during the production of the pigment paste, which poses a high demand on the dispersion's shear stability. On the other hand, any component that increases the water sensitivity of the paint needs to be minimized so that the weather resistance of the paint is not compromised. Accordingly, the content of rheology modifiers such as thickeners needs to be kept at a minimum level while still ensuring an adequate high viscosity of the house paints for optimum workability. The applied polymer dispersion hence needs to exhibit a high response to thickeners to achieve high paint viscosities at a low thickener content. It has been challenging to balance the demand of high thickener response and good shear stability as these parameters pose different and sometimes opposing requirements regarding the stabilization package of the polymer dispersion.

### SUMMARY OF THE INVENTION

A coating composition of the present disclosure may comprise: a) a pigment; b) a filler; c) a polymer dispersion comprising a polymer produced by free-radically initiated emulsion polymerization of a mixture of ethylenically unsaturated monomers; and d) a thickener. The mixture of ethylenically unsaturated monomers may comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers, wherein a sum of the carboxylic acid-functional monomers and the sulfonic acid-functional monomers is 2.5 wt % to 3.5 wt %, based on a total weight of the mixture of ethylenically unsaturated monomers.

A polymer dispersion of the present disclosure may comprise: a polymer produced by free-radically initiated emulsion polymerization of a mixture of ethylenically unsaturated monomers, wherein the mixture of ethylenically unsaturated monomers comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers, wherein a sum of the carboxylic acid-functional monomers and the sulfonic acid-functional monomers is 2.5 wt % to 3.5 wt %, based on a total weight of the mixture of ethylenically unsaturated monomers.

A polymer of the present disclosure may comprise: 125 to 250 μmol carboxylic acid units per gram of the polymer, 45 to 90 μmol sulfonic acid units per gram of the polymer, and a total amount of carboxylic acid units and sulfonic acid units of 200 to 300 μmol per gram of the polymer.

### DETAILED DESCRIPTION OF THE INVENTION

### Introduction

Described herein are polymer dispersions as well as coating compositions (e.g., paints) incorporating the polymer dispersions. The polymer dispersion comprises a polymer produced by free-radically initiated emulsion polymerization of a mixture of ethylenically unsaturated monomers. Specifically, the mixture of ethylenically unsaturated monomers includes a low concentration of carboxylic acid-functional monomers and sulfonic acid-functional monomers, both individually and in combination. Without being limited by theory, it is believed that balancing the amount carboxylic acid groups and sulfonic acid groups in the polymer produced by emulsion polymerization may allow for low concentrations of thickeners in coating composition while conferring adequate shear stability.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references, e.g., meaning “one or more,” unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

As used herein, the term “comprises” and variations thereof is open-ended, but for purposes of the specification and as support for future claim amendments, it should be understood as alternatively disclosing more restrictive language, such as “consisting essentially of” or “consisting of.”

### Polymer Dispersions

The coating compositions described herein include an aqueous polymer dispersion system that contains polymer particles in disperse distribution as the disperse phase in an aqueous medium. The polymer dispersions can be prepared as monomer mixtures in an aqueous medium and then polymerized, for example through an emulsion polymerization, to produce the polymer dispersion. In some aspects, the emulsion polymerization process is a free radically initiated polymerization.

The monomer mixture of the aqueous dispersion, prior to polymerization, contains a mixture of ethylenically unsaturated monomers. Specifically, the mixture of ethylenically unsaturated monomers includes a low concentration of carboxylic acid-functional monomers and sulfonic acid-functional monomers, both individually and in combination. Without being limited by theory, it is believed that a minimum level of carboxylic acid groups are needed in the resultant polymer to allow for sufficient shear stability. However, too high a level of carboxylic acid groups may prevent thickeners, especially polyurethane thickeners, from effectively increasing the viscosity of a coating composition produced with the polymer dispersion. Accordingly, the present disclosure relates to balancing the carboxylic acid groups and sulfonic acid groups in the polymer produced by emulsion polymerization by controlling the concentration of carboxylic acid-functional monomers and sulfonic acid-functional monomers both individually and in total.

The carboxylic acid-functional monomers may be present in the mixture of ethylenically unsaturated monomers in an amount from 1.0 to 2.0 weight percent (wt %) (e.g., from 1.0 to 1.75 wt %, from 1.1 to 1.75 wt %, from 1.2 to 1.75 wt %, or from 1.2 to 1.7 wt %), based on the weight of the mixture of ethylenically unsaturated monomers.

The sulfonic acid-functional monomers may be present in the mixture of ethylenically unsaturated monomers in an amount from 1.0 to 2.0 wt % (e.g., from 1.0 to 1.75 wt %, from 1.1 to 1.75 wt %, from 1.2 to 1.75 wt %, or from 1.2 to 1.7 wt %), based on the weight of the mixture of ethylenically unsaturated monomers.

A total concentration of carboxylic acid-functional monomers and sulfonic acid-functional monomers may be present in the mixture of ethylenically unsaturated monomers in an amount from 2.5 to 3.5 wt % (e.g., from 2.5 to 3.25 wt %, from 2.75 to 3.25 wt %, from 2.75 to 3.1 wt %, or from 2.75 to 3.0 wt %), based on the weight of the mixture of ethylenically unsaturated monomers. Any combination of ranges of the carboxylic acid-functional monomers concentration and ranges of the sulfonic acid-functional monomers concentration may be used provided the total concentration is within at least one of the foregoing ranges.

Examples of carboxylic acid-functional monomers may include, but are not limited to, an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, the like, and any combination thereof. Preferably, one or both of methacrylic acid and acrylic acid may be included in the carboxylic acid-functional monomers.

Examples of sulfonic acid-functional monomers may include, but are not limited to, vinyl sulfonic acid, 2-acrylamido-2-methylpropanesulfonic acid, an alkali metal salt of vinyl sulfonic acid, an alkali metal salt of 2-acrylamido-2-methylpropanesulfonic acid, an ammonium salt of vinyl sulfonic acid, an ammonium salt of 2-acrylamido-2-methylpropanesulfonic acid, the like, and any combination thereof. A preferred sulfonic-acid functional monomer is the sodium salt of 2-acrylamido-2-methylpropanesulfonic acid.

In addition to carboxylic acid-functional monomers and sulfonic acid-functional monomers, the monomer mixture may comprise additional stabilizing monomers such as ethylenically unsaturated phosphonic and phosphoric acids, such as vinylphosphonic acid, esters of phosphonic or phosphoric acid with hydroxyalkyl (meth)acrylates and ethylenically unsaturated polyethoxyalkylether phosphates, and ethylenically unsaturated carboxylic amides, such as methacrylamide and acrylamide. Preferably, the combined amount of these additional stabilizing monomers is smaller than the combined amount of carboxylic- and sulfonic acid-functional monomers. More preferably, the combined amount of these additional stabilizing monomers is less than half of the combined amount of carboxylic- and sulfonic acid-functional monomers. Most preferably, the monomer mixture does not comprise any other stabilizing monomers than carboxylic acid- and sulfonic acid-functional monomers.

Examples of other monomers that may be included in the mixture of ethylenically unsaturated monomers may include, but are not limited to, aldehyde or keto group-containing monomers, C₁-C₁₈ alkyl esters of acrylic acid, C₁-C₁₈ alkyl esters of methacrylic acid, vinyl aromatic monomers (e.g., styrene and vinyltoluene), vinyl halogenide monomers, acrylonitrile, methacrylonitrile, vinyl esters (e.g., vinyl acetate), olefins (e.g., ethylene and butadiene), the like, and any combination thereof. In some embodiments, the monomer mixture can optionally contain further functional co-monomers, including, for example, unsaturated silane co-monomers, epoxy-functional co-monomers, ureido co-monomers, hydroxy-functional co-monomers, polyfunctional co-monomers and combinations of these optional functional co-monomers.

Examples of keto group-containing monomers may include, but are not limited to polymerizable derivatives of diacetone (e.g., diacetone acrylamide (DAAM) and diacetone methacrylamide), butanonemethacrylic esters, polymerizable 1,3-dicarbonyl compounds (e.g., acetoacetoxyethyl acrylate, acetoacetoxyethyl methacrylate (AAEM), acetoacetoxypropyl methacrylate, acetoacetoxybutyl methacrylate, 2,3-di(acetoacetoxy) propyl methacrylate, and allyl acetoacetate), and polymerizable 1,3-diketoamides (e.g., those compounds described in U.S. Pat. No. 5,889,098, which patent is incorporated herein by reference). Examples of suitable 1,3-diketoamides include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like. Diacetone acrylamide is a particularly preferred keto group-containing monomer.

Examples of C₁-C₁₈ alkyl esters of acrylic acid and C1-C₁₈ alkyl esters of methacrylic acid may include, but are not limited to, ethyl acrylate, n-butyl acrylate, iso-butyl acrylate, tert-butyl acrylate, n-octyl acrylate, 2-octyl acrylate, 2-ethylhexyl acrylate, 2-ethylhexyl methacrylate, 2-propylheptyl acrylate, lauryl acrylate, isodecyl methacrylate, lauryl methacrylate, tridecyl acrylate, methyl methacrylate, cyclohexyl methacrylate, isobornyl acrylate, isobornyl methacrylate, the like, and any combination thereof. Preferably, the monomer mixture comprises at least one C₈-C₁₈ alkyl ester of either acrylic or methacrylic acid.

When included, the aldehyde or keto group-containing monomers may be present in the mixture of ethylenically unsaturated monomers in an amount from 0.1 to 5 wt % (e.g., from 0.1 to 4 wt %, from 0.1 to 3 wt %, from 0.5 to 3 wt %, or from 0.5 to 2 wt %), based on the weight of the mixture of ethylenically unsaturated monomers.

When included, the C₁-C₁₈ alkyl esters of acrylic acid and/or C₁-C₁₈ alkyl esters of methacrylic acid, in total, may be present in the mixture of ethylenically unsaturated monomers in an amount of at least 50 wt % (e.g., from 50 to 97.5 wt %, from 65 to 97 wt %, from 80 to 96 wt %, or from 90 to 96 wt %), based on the weight of the mixture of ethylenically unsaturated monomers.

When included, the vinyl aromatics may be present in the mixture of ethylenically unsaturated monomers in an amount from 1 to 10 wt % (e.g., from 1 to 8 wt %, from 3 to 8 wt %, or from 5 to 8 wt %), based on the weight of the mixture of ethylenically unsaturated monomers.

In addition to the monomers described herein, the polymer dispersion may also contain a cross-linking agent, which is preferably added after polymerization of the monomer composition. Such a cross-linking agent can react with specific polymer functionalities, such as keto groups, for example. In some embodiments, the cross-linking agent can react with specific polymer functionalities as water is removed from the polymer dispersion and as a film is formed from the polymerized components. In some embodiments, the cross-linking agent can be a water-soluble cross-linking agent.

Suitable cross-linking agents that can be used in the compositions herein comprise polyfunctional carboxylic hydrazides and/or polyfunctional amines, where the molar ratio of hydrazide and/or amine groups to keto groups in the polymer dispersion ranges from 0.5:1 to 2:1.

Examples of suitable polyfunctional carboxylic hydrazides are dihydrazide compounds of aliphatic dicarboxylic acids of 2 to 10, in particular 4 to 6, carbon atoms, e.g., oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Water-soluble aliphatic dihydrazines of 2 to 4 carbon atoms, e.g., ethylene-1,2-dihydrazine, propylene-1,3-dihydrazine or butylene-1,4-dihydrazine, are also suitable. Adipic acid dihydrazide (ADH) is a preferred water-soluble cross-linking agent for use in the compositions herein, especially those produced from monomer compositions which comprise diacetone acrylamide (DAAM).

Examples of suitable polyfunctional amines include ethylene diamine and hexamethylene diamine. Such cross-linking agents are preferred in combination with polymers which comprise a monomer comprising 1,3-dicarbonyl groups, such as acetoacetoxyethyl methacrylate (AAEM).

The polymer dispersion disclosed herein may be prepared by a customary processes of emulsion polymerization, where the monomers may be emulsified in the aqueous phase in the presence of emulsifiers, initiators, and optionally protective colloids, and are advantageously polymerized at temperatures from 60° C. to 95° C. These processes are familiar to those skilled in the art and may be carried out by batch processes, metered-monomer processes, or emulsion-feed processes. The emulsion-feed process allows a small amount of the monomers to be pre-polymerized and then the remainder of the monomers is metered in the form of an aqueous emulsion. The process may involve polymerization in one, two, and more stages with different monomer combinations. Preferably, a single stage polymerization is performed, producing a homogeneous polymer dispersion with one defined glass transition temperature.

The initiators may include, without limiting the scope of the embodiments of the disclosed invention, one or more free radical initiators. Suitable free radical initiators may include, but are not limited to, hydrogen peroxide, benzoyl peroxide, cyclohexanone peroxide, isopropyl cumyl hydroperoxide, persulfates of potassium, sodium or ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl) hexanoyl peroxide, tert-butyl perpivalate, hydroperoxypinane, p-methane hydroperoxide. The above-mentioned compounds can also be used within redox systems, using transition metal salts, such as iron(II) salts, or other reducing agents. Alkali metal salts of oxymethane sulfonic acid, hydroxylamine salts, sodium dialkyldithiocarbamate, sodium bisulfite, ammonium bisulfite, disodium 2-hydroxy-2-sulfonic acetic acid, disodium 2-hydroxy-2-sulfonic acetic acid, sodium dithionite, diisopropyl xanthogen disulfide, ascorbic acid, tartaric acid, and isoascorbic acid can also be used as reducing agents.

In some embodiments, from 0.01 to 1 wt %, such as from 0.02 to 0.2 wt %, based on the based on the weight of the mixture of ethylenically unsaturated monomers, of a at least one chain transfer agent is used during the emulsion polymerization process. Important classes of chain transfer agents are listed in the Handbook of Radical Polymerization, K. Matyjaszewski, T.P. Davis, Wiley-Interscience, 2003. Preferred chain transfer agents are mercaptans with one or multiple thiol groups such as methylthiol, ethylthiol, n-propylthiol, n-butylthiol, n-hexylthiol, n-octylthiol, n-decylthiol, n-dodecylthiol, n-tetradecylthiol, n-hexadecylthiol, n-octadecylthiol, cyclohexylthiol, isopropylthiol, tert-butylthiol, tert-nonylthiol, tert-dodecylthiol, 4-methylbenzene thiol, 2-mercaptopropionic acid, isooctyl 3-mercaptopropionate, 4,4′-thiobisbenzenethiol, pentaerythritol tetrakis(2-mercaptoacetate) and pentaerythritol tetrakis(3-mercaptopropionate).

Based on the content of polymer, the polymer dispersions preferably comprise 0.3-3 wt % (e.g., 0.5 to 2 wt %, 0.7 to 1.75 wt %, or 1.0 to 1.5 wt %) of ionic emulsifiers, and no more than 4 wt % (e.g., no more than 2 wt %, no more than 1 wt %, or more than 0.5 wt %) of nonionic emulsifiers, each based on the total weight of mixture of ethylenically unsaturated monomers.

Examples of suitable nonionic emulsifiers may include, but are not limited to, alkyl polyglycol ethers (e.g., ethoxylation products of fatty alcohols such as lauryl, oleyl, or stearyl alcohol, or mixtures of the same, e.g., coconut fatty alcohol, or ethoxylation products of oxo-process alcohols), ethoxylation products of polypropylene oxide, the like, and any combination thereof. Also, copolymerizable nonionic surfactants can be employed. Particularly suitable are ethylene oxide ethers with a degree of ethoxylation from 20 to 40 of C₁₀ to C₁₈ alkyl alcohols. Preferably, no alkylphenol ethoxylates are used.

Suitable ionic emulsifiers are anionic emulsifiers, which may, for example, be the alkali metal or ammonium salts of alkyl-, aryl- or alkylaryl sulfonates or -phosphonates, or of alkyl, aryl, or alkylaryl sulfates, or of alkyl, aryl, or alkylaryl phosphates, or compounds with other anionic end groups, and it is also possible here for there to be oligo- or polyethylene oxide units between the hydrocarbon radical and the anionic group. Typical examples are sodium lauryl sulfate, sodium undecyl glycol ether sulfate, sodium lauryl diglycol sulfate, sodium tetradecyl triglycol sulfate, sodium dodecylbenzenesulfonate. Also, copolymerizable anionic surfactants may be used. Sodium alkyl ether sulfates with a mean degree of ethoxylation between 2 and 15 are particularly preferred. Preferably, no alkylphenol ethoxylates including derivatives thereof are employed.

In some embodiments, the polymer dispersions and compositions containing such dispersions described herein can be substantially free of protective colloids as stabilizing agents. Examples of protective colloids include carboxymethyl cellulose (CMC), hydroxyethyl cellulose (HEC), and polyvinyl alcohol (PVOH). Such polymer dispersions are considered to be “substantially free” of protective colloids when protective colloids comprise no more than 0.5 wt %, e.g., no more than 0.2 wt % or no more than 0.1 wt %, based on the total weight of the mixture of ethylenically unsaturated monomers. In a particularly preferred embodiment, the dispersions comprise neither protective colloids nor nonionic emulsifiers.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e. distillative removal, especially by means of steam distillation, or by stripping with an inert gas. In some aspects, the total residual monomer content of the polymer dispersion may be less than 500 ppm, e.g. less than 300 ppm, preferably less than 200 ppm, or less than 100 ppm as determined by gas chromatography according to ISO 11890-2 (2020).

The polymer dispersions produced by the process described herein generally have a solids content of from 30 to 65 wt % (e.g., 45 to 55 wt %), and a pH between 3.0 and 10.0 (e.g., between 4.0 and 9.0, or between 6.0 and 8.5). The pH value of the dispersion may be raised by addition of an organic or inorganic base, such as an amine or an alkali metal hydroxide, such as sodium or potassium hydroxide. In some embodiments, it is preferred to effect neutralization with a nitrogen-free base. The polymer dispersions described herein are usually free of ammonia or ammonium salts.

The polymer of the polymer dispersion may have 125 to 250 μmol (e.g., 135 to 225 μmol) carboxylic acid units per gram polymer, 45 to 90 μmol (e.g., 50 to 85 μmol) sulfonic acid units per gram polymer, such that the total amount of carboxylic acid units and sulfonic acid units is 200 to 300 μmol (e.g., 210 to 275 μmol) per gram of polymer.

The polymer dispersions described herein may be protected against microbial attack through addition of biocides. They may also be free of biocides. In other embodiments, to increase the shelf life of the polymer dispersions, biocides may be added that can be decomposed during subsequent preparation of the coating composition to yield a preservative-free coating. For example, 2,2-dibromo-3-nitrilopropionamide (DBNPA) readily decomposes at pH values above 7. 5-chloro-2-methyl-3 (2H)-isothiazolone (CIT) can be decomposed either through increase of the pH, preferably to at least 10, or by addition of, e.g., cysteine to the coating composition.

The weight-average particle size (d_{w}) of the polymer dispersion may be 150 nm or less (e.g., 125 nm or less, 60 nm to 150 nm, 75 nm to 125 nm, or 90 nm to 125 nm), as determined by laser diffraction and polarization intensity differential scattering (PIDS) using a Beckman Coulter LS 13320 Particle Size Analyzer.

In some aspects, the polymer dispersions may be prepared under conditions to produce a polymer with a uniform glass transition temperature. In some aspects, the glass transition temperature of the polymer comprised in polymer dispersion is 15° C. or lower (e.g., from −15° C. to 15° C., from −15° C. to 10° C., or from −5 to 10° C.), as determined by differential scanning calorimetry according to ISO 16805. The glass transition temperature may be selected so as to have a low enough value that a coalescent agent is not needed. Coalescent agents are known to be the main contributors to VOCs in coating applications and are therefore preferably excluded from the coating compositions and polymer dispersions described herein.

In some aspects, the Brookfield viscosity of the polymer dispersion is from 500 to 10,000 mPa·s (e.g., 1000 to 8000 mPa-s, or 2000 to 6000 mPa·s), as measured at 20° C., 20 rpm, spindle 4.

In some aspects, the coagulum content of the unfiltered polymer dispersion may be less than 0.02% (e.g., less than 0.01%, or less than 0.005%) as determined by filtration over a filter with 180 μm mesh size.

### Coating Compositions

The coating compositions herein are prepared from using the polymer dispersions described herein. The essential components of the coating compositions herein are most commonly combined with other components, which are conventionally used to form coating compositions (e.g., paint compositions). Coating compositions may be formulated using techniques known to those skilled in the art of manufacturing coating compositions like paints. Generally, water, defoamer, pigment, filler (also known as extender pigment), and surfactant stabilizer (in addition to emulsifiers used during emulsion polymerization of the polymer in the polymer dispersion described herein) or dispersing agent are combined to form a grind, where the pigments and fillers are ground to a desired particle size. Due to the high binder content of house paints, it may be necessary to do the grinding process of pigments and fillers in presence of at least a part of the polymer dispersion, such as at least 5 wt. %, or at least 10 wt. %, based on the overall amount of polymer dispersion in the coating. The remainder of the polymer dispersion is then added to the filler/pigment paste which is still hot or also cooled, under rapid or also slower stirring.

Preferred fillers useful in the coating compositions herein may include, but are not limited to, calcium carbonate, magnesite, dolomite, kaolin, mica, talc, silica, calcium sulfate, feldspar, barium sulfate and opaque polymer. Examples of white pigments useful in the coating compositions herein can be zinc oxide, zinc sulfide, basic lead carbonate, antimony trioxide, lithopone (zinc sulfide+barium sulfate) and, preferably, titanium dioxide. Examples of inorganic colored pigments which may preferably be used in the coating compositions herein may include, but are not limited to, iron oxides, carbon black, graphite, luminescent pigments, zinc yellow, zinc green, Paris blue, ultramarine, manganese black, antimony black, manganese violet or Schweinfurt green. Suitable organic colored pigments may include, but are not limited to, sepia, gamboge, Cassel brown, toluidine red, para red, Hansa yellow, indigo, azo dyes, anthraquinone and indigo dyes as well as dioxazine, quinacridone, phthalocyanin, isoindolinone and metal complex pigments of the azomethine series.

The fillers may be used as individual components. Mixtures of fillers such as, for example, calcium carbonate/kaolin and calcium carbonate/kaolin/talc have also been found to be particularly useful in practice. To increase the hiding power of the coating and to save on titanium dioxide, finely divided fillers such as, for example, finely divided calcium carbonate and mixtures of various calcium carbonates with different particle size distribution are frequently used. Calcined clays are commonly used to increase film dry opacity as they help incorporate air voids into the dry film. Air voids create a big difference in refractive index in the film and scatter light, yielding more opacity in the film once cured. To adjust the hiding power, the shade and the depth of color of the coatings formed, the fillers are mixed with appropriate amounts of white pigment and inorganic and/or organic colored pigments. In some embodiments, hollow polymer particles may be used to increase the dry hiding power of the coatings.

To disperse the fillers and pigments in water, 0.1 to 0.6% by weight, based on the total weight of the coating composition, of auxiliaries based on anionic or nonionic wetting agents, such as preferably, for example, sodium pyrophosphate, sodium polyphosphate, naphthalenesulfonate, sodium polyacrylate, sodium polymaleinates and polyphosphonates such as sodium 1-hydroxyethane-1,1-diphosphonate and sodium nitrilotris(methylenephosphonate), may be added.

The coating compositions herein will preferably have a pigment volume concentration (PVC) of about 60% or less (e.g., 30% to 60%, or 40% to 55%). PVC represents the volume of pigments plus fillers in the coating composition divided by the volume of pigments, fillers, and binders (including the polymer of the polymer dispersion described herein) times 100%. PVC is described in greater detail in U.S. Patent Publication No. 2010/0056696 which is incorporated herein by reference.

Thickeners may also be added to the coating compositions herein. Thickeners which may be used include, inter alia, preferably cellulose derivates such as methylcellulose (MC), hydroxyethylcellulose (HEC) and carboxymethyl-cellulose. Other thickeners which may be used include casein, gum arabic, gum tragacanth, starch, sodium alginate, polyvinyl alcohol, polyvinylpyrrolidone, sodium polyacrylate and water-soluble copolymers based on acrylic and methacrylic acid, such as acrylic acid/acrylamide and methacrylic acid/acrylic ester copolymers. Hydrophobically-modified alkali soluble (acrylic) emulsions (HASE), hydrophobically-modified ethoxylated (poly) urethanes (HEUR), hydrophobically-modified ethoxylated (poly) urethane alkali-swellable/soluble emulsions (HEURASE), and polyether polyols (PEPO) are also available. Inorganic thickeners, such as, for example, bentonites or hectorite, may also be used. Preferred thickeners include hydrophobically-modified ethoxylated (poly) urethanes (HEUR), hydrophobically-modified ethoxylated (poly) urethane alkali-swellable/soluble emulsions (HEURASE), and any combination thereof.

Thickeners may be present in the coating formulation in amounts ranging from about 0.05 to 2 wt % (e.g., about 0.1 to 0.5 wt %), based on the total weight of the coating formulation.

For various applications, it may also be desirable to include small amounts of other additives, such as bactericides, pH modifiers, and antifoamers, incorporated in the coating compositions herein. This may be done in a conventional manner and at any convenient point in the preparation of the polymer dispersion.

The aqueous copolymer dispersion described herein is particularly useful as binder for waterborne coatings with low emission regarding Total Volatile Organic Compound (TVOC) and Total Semi Volatile Organic Compound (TsVOC) contents. A volatile organic compound is defined herein as a carbon containing compound that has a boiling point below 250° C. at atmospheric pressure (as defined in the Commission Decision 2014/312/EU). The TVOC content may be determined by gas chromatography according to ISO 11890-2, or alternatively for products with a VOC content of less than 1.0 g/L according to ISO 17895. sVOC compounds have a boiling point above 250° C. (as defined in detail in the Commission Decision 2014/312/EU) and may be determined by gas chromatography according to ISO 11890-2.

Main contributors to VOC/sVOC are coalescent agents which reduce the minimum film-forming temperature (MFT), such as butyl glycol, butyl diglycol, butyl diglycol acetate, 1-methoxy-2-propanol, 3-methoxy-1-butanol, texanol, ethyl diglycol, dipropylene glycol monomethyl ether, and dipropylene glycol n-butyl ether, and plasticizers, which increase the elasticity of the coating, such as 2,2,4-trimethyl-1,3-pentanediol diisobutyrate (TXIB), hexylene glycol, triethylene glycol-bis-2-ethylhexanoate (3G8), LOXANOL® PL 3060, and BENZOFLEX™. Further VOC sources may include co-solvents, including glycols, which help with wet edge application, open time, and freeze-thaw resistance, emulsion components and most additives at low levels. For instance, amino methyl propanol is a volatile compound used to adjust pH.

Commercially available coating compositions may have VOC levels exceeding 50 g/L. In contrast, the coating compositions described herein can have a VOC content of less than about 5 g/L (e.g., less than 1 g/L) and a sVOC content of less than 1 g/L (e.g., less than 0.5 g/L).

In some aspects, the Brookfield viscosity of the coating compositions described herein is 12,000 mPa·s or greater (e.g., 15,000 mPa·s or greater, 12,000 to 30,000 mPa·s, or 15,000 to 25,000 mPa·s), as measured at 20° C., 20 rpm, spindle 4.

Upon curing, the polymer of the polymer dispersion described herein in the coating compositions herein form a film or coating which will adhere to a substrate onto which the coating composition has been applied. The film or coating seals and protects the substrate.

The minimum temperature required for the polymers in the coating composition to form a coating or film is referred to as the minimum film-forming temperature or MFT. MFT is related to the glass transition temperature, Tg, of the polymer of the polymer dispersion, but can also be affected by other components of such coating compositions such as coalescents. The coating compositions herein may preferably have a MFT of equal to or less than about 5° C. The coating compositions herein may preferably have a MFT of about 5° C. or less (e.g., 3° C. or less, or 1° C. or less) and be free of organic solvent, plasticizer, coalescent agent, or any combination thereof.

The coating compositions herein may form films or coatings which exhibit excellent adhesion onto dry substrates or hard surfaces to which such compositions have been applied. The films/coatings so formed will also exhibit excellent wet adhesion characteristics. Wet adhesion refers to the ability of coating from a coating composition to adhere to a substrate under wet conditions. Wet adhesion is a critical property not only for exterior paints, but also for some interior applications, such as in kitchens and bathrooms.

Wet Adhesion and Dry Adhesion performance of the coating compositions herein can be quantified by means of testing in accordance with the modified procedure of ASTM Test No. D 3359 as described hereinafter in the Test Methods section. The coating compositions herein will preferably form coatings/films which exhibit a rating of at least about 3 when tested in this manner.

The following numbered embodiments are contemplated. All combinations of features and embodiments are contemplated.

Embodiment 1. A coating composition (e.g., a paint) comprising: a) a pigment; b) a filler; c) a polymer dispersion comprising a polymer produced by free-radically initiated emulsion polymerization of a mixture of ethylenically unsaturated monomers, wherein the mixture of ethylenically unsaturated monomers comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers, wherein a sum of the carboxylic acid-functional monomers and the sulfonic acid-functional monomers is 2.5 wt % to 3.5 wt %, based on a total weight of the mixture of ethylenically unsaturated monomers; and d) a thickener.

Embodiment 2. The coating composition according to Embodiment 1, wherein the mixture of ethylenically unsaturated monomers comprise 1.1 wt % to 1.75 wt % carboxylic acid-functional monomers, based on a total weight of the mixture of ethylenically unsaturated monomers.

Embodiment 3. The coating composition according to any preceding Embodiment, wherein the mixture of ethylenically unsaturated monomers comprise 1.1 wt % to 1.75 wt % sulfonic acid-functional monomers, based on a total weight of the mixture of ethylenically unsaturated monomers.

Embodiment 4. The coating composition according to any preceding Embodiment, wherein the sum of the carboxylic acid-functional monomers and the sulfonic acid-functional monomers is 2.75 wt % to 3.25 wt %, based on a total weight of the mixture of ethylenically unsaturated monomers.

Embodiment 5. The coating composition according to any preceding Embodiment, wherein the polymer of the polymer dispersion has 125 to 250 μmol carboxylic acid units per gram of the polymer, 45 to 90 μmol sulfonic acid units per gram of the polymer, and a total amount of carboxylic acid units and sulfonic acid units of 200 to 300 μmol per gram of the polymer.

Embodiment 6. The coating composition according to any preceding Embodiment, wherein the thickener comprises a polyurethane.

Embodiment 7. The coating composition according to any preceding Embodiment, wherein the polymer of the polymer dispersion has a glass transition temperature of −15° C. to 15° C., as determined by differential scanning calorimetry according to ISO 16805 (2005).

Embodiment 8. The coating composition according to any preceding Embodiment, wherein the coating composition has a minimum film forming temperature of less than 5° C.

Embodiment 9. The coating composition according to any preceding Embodiment, wherein the coating composition has a pigment volume concentration of 30% to 60%, based on a total volume of the coating composition.

Embodiment 10. The coating composition according to any preceding Embodiment, wherein the coating composition has a Brookfield viscosity of 12,000 mPa·s or greater, as measured at 20° C., 20 rpm, spindle 6.

Embodiment 11. The coating composition according to any preceding Embodiment, wherein the carboxylic acid-functional monomers comprise an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, or any combination thereof.

Embodiment 12. The coating composition according to any preceding Embodiment, wherein the sulfonic acid-functional monomers comprise vinyl sulfonic acid, 2-acrylamido-2-methylpropanesulfonic acid, an alkali metal thereof, an ammonium salt thereof, or any combination thereof.

Embodiment 13. The coating composition according to any preceding Embodiment, wherein the mixture of ethylenically unsaturated monomers further comprise at least 50 wt %, based on a total weight of the mixture of ethylenically unsaturated monomers, C₁-C₁₈ alkyl esters of acrylic acid and/or C₁-C₁₈ alkyl esters of methacrylic acid.

Embodiment 14. The coating composition according to any preceding Embodiment, wherein the mixture of ethylenically unsaturated monomers further comprise keto-containing co-monomers, aldehyde-containing co-monomers, or any combination thereof.

Embodiment 15. The coating composition according to any preceding Embodiment, wherein the mixture of ethylenically unsaturated monomers are devoid of one or more of: an ethylenically unsaturated phosphonic acid, an ethylenically unsaturated phosphoric acid, an ethylenically unsaturated ester of phosphonic acid with hydroxyalkyl(meth)acrylate, an ethylenically unsaturated ester of phosphoric acid with hydroxyalkyl(meth)acrylate, an ethylenically unsaturated polyethoxyalkylether phosphate, and an ethylenically unsaturated carboxylic amide.

Embodiment 16. The coating composition according to any one of Embodiments 1-14, wherein the mixture of ethylenically unsaturated monomers used to form the polymer does not comprise methacrylamide and/or acrylamide.

Embodiment 17. The coating composition according to any preceding Embodiment, wherein the coating composition is free of organic solvent, plasticizer, and/or coalescent agent.

Embodiment 18. A process for preparing a coating composition according to any preceding Embodiment, wherein at least 5 wt % of the total amount of polymer dispersion in the coating composition is present during the preparation of the pigment paste.

Embodiment 19. A polymer dispersion comprising: a polymer produced by free-radically initiated emulsion polymerization of a mixture of ethylenically unsaturated monomers, wherein the mixture of ethylenically unsaturated monomers comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers, wherein a sum of the carboxylic acid-functional monomers and the sulfonic acid-functional monomers is 2.5 wt % to 3.5 wt %, based on a total weight of the mixture of ethylenically unsaturated monomers.

Embodiment 20. A polymer comprising: 125 to 250 μmol carboxylic acid units per gram of the polymer, 45 to 90 μmol sulfonic acid units per gram of the polymer, and a total amount of carboxylic acid units and sulfonic acid units of 200 to 300 μmol per gram of the polymer.

Embodiment 21. The polymer according to Embodiment 20, wherein the mixture of ethylenically unsaturated monomers comprise 1.1 wt % to 1.75 wt % carboxylic acid-functional monomers, based on a total weight of the mixture of ethylenically unsaturated monomers.

Embodiment 22. The polymer according to Embodiment 20 or 21, wherein the mixture of ethylenically unsaturated monomers comprise 1.1 wt % to 1.75 wt % sulfonic acid-functional monomers, based on a total weight of the mixture of ethylenically unsaturated monomers.

Embodiment 23. The polymer according to any one of Embodiments 20-22, wherein the sum of the carboxylic acid-functional monomers and the sulfonic acid-functional monomers is 2.75 wt % to 3.25 wt %, based on a total weight of the mixture of ethylenically unsaturated monomers.

Embodiment 24. The polymer according to any one of Embodiments 20-23, wherein the polymer of the polymer dispersion has 135 to 225 μmol carboxylic acid units per gram of the polymer, 50 to 85 μmol sulfonic acid units per gram of the polymer, and a total amount of carboxylic acid units and sulfonic acid units of 210 to 275 μmol per gram of the polymer.

Embodiment 25. The polymer according to any one of Embodiments 20-24, wherein the carboxylic acid-functional monomers comprise an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, or any combination thereof.

Embodiment 26. The polymer according to any one of Embodiments 20-25, wherein the sulfonic acid-functional monomers comprise vinyl sulfonic acid, 2-acrylamido-2-methylpropanesulfonic acid, an alkali metal thereof, an ammonium salt thereof, or any combination thereof.

Embodiment 27. The polymer according to any one of Embodiments 20-26, wherein the mixture of ethylenically unsaturated monomers further comprise at least 50 wt %, based on a total weight of the mixture of ethylenically unsaturated monomers, C₁-C₁₈ alkyl esters of acrylic acid and/or C₁-C₁₈ alkyl esters of methacrylic acid.

Embodiment 28. The polymer according to any one of Embodiments 20-27, wherein the mixture of ethylenically unsaturated monomers further comprise keto-containing co-monomers, aldehyde-containing co-monomers, or any combination thereof.

Embodiment 29. The polymer according to any one of Embodiments 20-28, wherein the mixture of ethylenically unsaturated monomers are devoid of one or more of: an ethylenically unsaturated phosphonic acid, an ethylenically unsaturated phosphoric acid, an ethylenically unsaturated ester of phosphonic acid with hydroxyalkyl(meth)acrylate, an ethylenically unsaturated ester of phosphoric acid with hydroxyalkyl(meth)acrylate, an ethylenically unsaturated polyethoxyalkylether phosphate, and an ethylenically unsaturated carboxylic amide.

Embodiment 30. The polymer according to any one of Embodiments 20-28, wherein the mixture of ethylenically unsaturated monomers used to form the polymer does not comprise methacrylamide and/or acrylamide.

### Examples

Example 1 (Inventive): A monomer feed was obtained by mixing the ingredients in Table 1 under stirring. Separately, a 3 liter reactor equipped with a reflux condenser and an anchor stirrer was filled with 600 g of deionized (DI) water and 21 grams of a 27 wt % active aqueous solution of a sodium alkyl ether sulfate with approximately 7 ethylene oxide units. The reactor content was heated to 80° C. and 2.5 wt % of the monomer feed was added (initial charge). A solution of 0.6 grams sodium persulfate in 12 grams of water was added and the reactor contents were held at 80° C. for 15 minutes (seed polymerization). Subsequently, the remaining amount of the monomer feed was added to the reactor with a constant dosage rate over 210 minutes. The reactor temperature was maintained at 80° C. during the monomer feed additions. After completion of the monomer feed additions, the reactor contents were held at 80° C. for another 60 minutes and then cooled to room temperature. The pH of the resulting dispersion was adjusted to approximately 8.5 with 5 wt % caustic soda, followed by addition of 90 g of a 10 wt % aqueous solution of adipic dihydrazide. The dispersion was protected against microbial attack by addition of 2.6 g ACTICIDE® MV (comprising an active content of 1.5 wt % 5-chloro-2-methyl-1,2-thiazol-3 (2H)-one/2-methyl-1,2-thiazol-3 (2H)-one (3:1), available from Thor) and 8.2 g MERGAL® K10N (comprising an active content of 9.5 wt % 1,2-benzothiazol-3 (2H)-one, available from Troy).

Examples 2-4 (Inventive): The process of Example 1 was repeated with different monomer feeds, as described in Table 1.

Examples 5-7 (Comparative): The process of Example 1 was repeated with different monomer feeds, as described in Table 1.

Table 2 provides the weight percent of each monomer in Examples 1-7 based on a total weight of monomers.

The properties of the resulting polymer dispersions are summarized in Table 3.

TABLE 1
Composition of the monomer feeds in total grams of Examples 1-7

| | Ex. 1 | Ex. 2 | Ex. 3 | Ex. 4 | Ex. 5 | Ex. 6 | Ex. 7 |
|---|---|---|---|---|---|---|---|
| deionized water | 540 | 540 | 540 | 540 | 540 | 540 | 540 |
| sodium alkyl ether | 43 | 43 | 43 | 43 | 43 | 43 | 43 |
| sulfate, 27% in water | | | | | | | |
| sodium persulfate | 4.2 | 4.2 | 4.2 | 4.2 | 4.2 | 4.2 | 4.2 |
| diacetone acrylamide | 18 | 18 | 18 | 18 | 18 | 18 | 18 |
| methacrylic acid | 9.6 | 12 | 14.4 | 19.2 | 0 | 7.2 | 24 |
| acrylic acid | 4.8 | 6 | 7.2 | 0 | 0 | 3.6 | 12 |
| sodium 2-acrylamido- | 42 | 36 | 30 | 36 | 60 | 48 | 0 |
| 2-methyl-1- | | | | | | | |
| propanesulfonate, | | | | | | | |
| 50% in water | | | | | | | |
| styrene | 84 | 84 | 84 | 84 | 84 | 84 | 84 |
| methyl methacrylate | 408 | 408 | 408 | 408 | 408 | 408 | 408 |
| n-butyl acrylate | 354 | 354 | 354 | 354 | 354 | 354 | 354 |
| 2-ethylhexyl acrylate | 354 | 354 | 354 | 354 | 354 | 354 | 354 |

TABLE 2
Composition of the monomer feeds in wt % of monomer
based on a total weight of monomer of Examples 1-7

| | Ex. 1 | Ex. 2 | Ex. 3 | Ex. 4 | Ex. 5 | Ex. 6 | Ex. 7 |
|---|---|---|---|---|---|---|---|
| diacetone acrylamide | 1.4 | 1.4 | 1.4 | 1.4 | 1.4 | 1.4 | 1.4 |
| methacrylic acid | 0.8 | 1.0 | 1.1 | 1.5 | 0.0 | 0.6 | 1.9 |
| acrylic acid | 0.4 | 0.5 | 0.6 | 0.0 | 0.0 | 0.3 | 1.0 |
| sodium 2-acrylamido- | 1.7 | 1.4 | 1.2 | 1.4 | 2.4 | 1.9 | 0.0 |
| 2-methyl-1- | | | | | | | |
| propanesulfonate | | | | | | | |
| styrene | 6.7 | 6.7 | 6.7 | 6.7 | 6.7 | 6.7 | 6.7 |
| methyl methacrylate | 32.6 | 32.5 | 32.5 | 32.5 | 32.7 | 32.6 | 32.5 |
| n-butyl acrylate | 28.2 | 28.2 | 28.2 | 28.2 | 28.4 | 28.3 | 28.2 |
| 2-ethylhexyl acrylate | 28.2 | 28.2 | 28.2 | 28.2 | 28.4 | 28.3 | 28.2 |

TABLE 3
Properties of the resulting polymers of Examples 1-7

| | Ex. 1 | Ex. 2 | Ex. 3 | Ex. 4 | Ex. 5 | Ex. 6 | Ex. 7 |
|---|---|---|---|---|---|---|---|
| Carboxylic acid units | 142 | 177 | 212 | 177 | 0 | 106 | 354 |
| (μmol/g polymer) | | | | | | | |
| Sulfonic acid units | 76 | 65 | 55 | 65 | 109 | 87 | 0 |
| (μmol/g polymer) | | | | | | | |
| Solid content (%)¹ | 47.6 | 47.5 | 47.5 | 47.8 | 48.1 | 47.3 | 46.5 |
| Brookfield viscosity | 7120 | 5780 | 4780 | 5900 | 6030 | 6680 | 2050 |
| (mPa · s)² | | | | | | | |
| pH | 8.3 | 8.4 | 8.3 | 8.4 | 8.3 | 8.5 | 8.3 |
| Coagulum content (%)³ | 0.001 | 0.000 | 0.001 | 0.000 | 0.002 | 0.001 | 0.002 |
| dw (nm)⁴ | 105 | 102 | 102 | 102 | 109 | 104 | 101 |
| Tg (° C.)⁵ | −0.9 | 0.6 | 1.1 | 0.7 | −3.4 | −2.2 | 4.2 |
| MFT (° C.)⁶ | 0 | 0 | 0 | 0 | 0 | 0 | 0 |
| Shear stability (min)⁷ | 6 | 7 | 8 | 6 | 0 | 2 | >10 |

¹gravimetric determination after 24 hours of drying at 110° C.
²measurement conditions: 20° C., 20 rpm, spindle 4
³as determined by filtration over a filter with 180 μm mesh size
⁴weight-average particle diameter as determined by a Beckman Coulter LS 13320 Particle Size Analyzer
⁵glass transition temperature as measured by differential scanning calorimetry (DSC) according to ISO 16805: 2003
⁶The minimum film forming temperature (MFT) is defined as the lowest temperature at which a polymer dispersion coalesces when laid on a substrate as a thin film, thereby forming clear transparent film.
⁷The compatibility of the polymer dispersion with fillers under shear is tested by mixing 220 grams OMYACARB ® 40GU (calcium carbonate, available from Omya), 110 grams OMYACARB ® 5GU (calcium carbonate, available from Omya), and 165 grams polymer dispersion as per Examples 1-7 in a metal beaker with a diameter of 8 cm. The ingredients are premixed until a homogeneous mixture is achieved (approximately 1 minute at 1000 rpm in high-speed mixer DISPERMAT ® CN F2 (available from VMA-Getzmann) equipped with a toothed stirring blade with a diameter of 6 cm). The stirring rate is then increased to 3000 rpm. The reported value is the time in minutes at this shear rate until coagulation of the mixture.

As evident from Table 3, all inventive examples 1˜4 exhibited a good shear stability. In contrast, comparative examples 5-6 with low concentrations of carboxylic acid-containing monomers have a low shear stability (<4 minutes).

Examples 8-14 are paints produced using the dispersion of Examples 1-7, respectively. The house paints were prepared by mixing the ingredients in Table 4 at room temperature under stirring. After dissolving and dispersing item nos. 2-5 in water, the pigment and fillers as per item nos. 6-8 were dispersed consecutively by increasing the dissolver speed to 5000 rpm. After the preparation of the mill base, item nos. 9-11 were added while gently stirring. The solid contents of all polymer dispersions in Examples 1-7 were adjusted to 45 wt % before their addition. The pigment volume concentration of the thus obtained house paints is 47.9%.

TABLE 4
Composition of the house paints

| | | | | Parts by |
|---|---|---|---|---|
| No. | Component | Supplier | Description | Weight |
| 1 | deionized water | | | 62 |
| 2 | AGITAN ® 282 | Münzing | defoamer | 4 |
| 3 | LOPON ® DA 401 | ICL | dispersing agent | 2 |
| 4 | AMP 90 | Angus | 2-amino-2-methyl-1-propanol, | 2 |
| | | | 90 wt % in water | |
| 5 | dispersions per examples 1-7 | | binder | 53 |
| 6 | KRONOS ® 2160 | Kronos | titanium dioxide | 225 |
| 7 | OMYACARB ® 5 GU | Omya | calcium carbonate | 175 |
| 8 | MICACELIA 125 L | Ziegler | muscovite mica | 55 |
| 9 | NaOH, 10% | | base | 2 |
| 10 | dispersions per examples 1-7 | | binder | 400 |
| 11 | COAPUR ™ 830 W (1:9 in | Coatex | polyurethane thickener | 20 |
| | DI water) | | | |

TABLE 5
Properties of the house paints

| | | | Brookfield viscosity |
|---|---|---|---|
| Paint | Comprising dispersion | | (mPa · s, after 14 days |
| Example No. | as per Example | | storage at room temperature)¹ |
| 8 | 1 | (inventive) | 18000 |
| 9 | 2 | (inventive) | 17500 |
| 10 | 3 | (inventive) | 15800 |
| 11 | 4 | (inventive) | 18750 |
| 12 | 5 | (comparative) | 22750 |
| 13 | 6 | (comparative) | 20800 |
| 14 | 7 | (comparative) | 11950 |

¹measurement conditions: 20° C., 20 rpm, spindle 6

As evident by Tables 3 and 5, only inventive dispersions exhibit sufficient shear stability when subjected to a filler mixture (>5 min at the specified test conditions) while at the same time providing a high response to polyurethane thickeners to yield house paints with adequate viscosity at low thickener content (>15000 mPa·s). While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A coating composition, comprising:
a) a pigment;
b) a filler;
c) a polymer dispersion comprising a polymer produced by free-radically initiated emulsion polymerization of a mixture of ethylenically unsaturated monomers,
wherein the mixture of ethylenically unsaturated monomers comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers,
wherein a sum of the carboxylic acid-functional monomers and the sulfonic acid-functional monomers is 2.5 wt % to 3.5 wt %, based on a total weight of the mixture of ethylenically unsaturated monomers; and
d) a thickener.

2. The coating composition according to claim 1, wherein the mixture of ethylenically unsaturated monomers comprise 1.1 wt % to 1.75 wt % carboxylic acid-functional monomers, based on a total weight of the mixture of ethylenically unsaturated monomers.

3. The coating composition according to claim 1, wherein the mixture of ethylenically unsaturated monomers comprises 1.1 wt % to 1.75 wt % sulfonic acid-functional monomers, based on a total weight of the mixture of ethylenically unsaturated monomers.

4. The coating composition according to claim 1, wherein the sum of the carboxylic acid-functional monomers and the sulfonic acid-functional monomers is 2.75 wt % to 3.25 wt %, based on a total weight of the mixture of ethylenically unsaturated monomers.

5. The coating composition according to claim 1, wherein the polymer of the polymer dispersion has 125 to 250 μmol carboxylic acid units per gram of the polymer, 45 to 90 μmol sulfonic acid units per gram of the polymer, and a total amount of carboxylic acid units and sulfonic acid units of 200 to 300 μmol per gram of the polymer.

6. The coating composition according to claim 1, wherein the thickener comprises a polyurethane.

7. The coating composition according to claim 1, wherein the polymer of the polymer dispersion has a glass transition temperature of −15° C. to 15° C., as determined by differential scanning calorimetry according to ISO 16805 (2005).

8. The coating composition according to claim 1, wherein the coating composition has a minimum film forming temperature of less than 5° C.

9. The coating composition according to claim 1, wherein the coating composition has a pigment volume concentration of 30% to 60%, based on a total volume of the coating composition.

10. The coating composition according to claim 1, wherein the coating composition has a Brookfield viscosity of 12,000 mPa·s or greater, as measured at 20° C., 20 rpm, spindle 6.

11. The coating composition according to claim 1, wherein the carboxylic acid-functional monomers comprise an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, or any combination thereof.

12. The coating composition according to claim 1, wherein the sulfonic acid-functional monomers comprise vinyl sulfonic acid, 2-acrylamido-2-methylpropanesulfonic acid, an alkali metal thereof, an ammonium salt thereof, or any combination thereof.

13. The coating composition according to claim 1, wherein the mixture of ethylenically unsaturated monomers further comprise at least 50 wt %, based on a total weight of the mixture of ethylenically unsaturated monomers, C₁-C₁₈ alkyl esters of acrylic acid and/or C₁-C₁₈ alkyl esters of methacrylic acid.

14. The coating composition according to claim 1, wherein the mixture of ethylenically unsaturated monomers further comprise keto-containing co-monomers, aldehyde-containing co-monomers, or any combination thereof.

15. The coating composition according to claim 1, wherein the mixture of ethylenically unsaturated monomers are devoid of one or more of: an ethylenically unsaturated phosphonic acid, an ethylenically unsaturated phosphoric acid, an ethylenically unsaturated ester of phosphonic acid with hydroxyalkyl(meth)acrylate, an ethylenically unsaturated ester of phosphoric acid with hydroxyalkyl(meth)acrylate, an ethylenically unsaturated polyethoxyalkylether phosphate, and an ethylenically unsaturated carboxylic amide.

16. The coating composition according to claim 1, wherein the mixture of ethylenically unsaturated monomers used to form the polymer does not comprise methacrylamide and/or acrylamide.

17. The coating composition according to claim 1, wherein the coating composition is free of organic solvent, plasticizer, and/or coalescent agent.

18. A process for preparing the coating composition according to claim 1, wherein at least 5 wt % of the total amount of polymer dispersion in the coating composition is present during the preparation of the pigment paste.

19. A polymer dispersion comprising:
a polymer produced by free-radically initiated emulsion polymerization of a mixture of ethylenically unsaturated monomers,
wherein the mixture of ethylenically unsaturated monomers comprise 1.0 wt % to 2.0 wt % carboxylic acid-functional monomers and 1.0 wt % to 2.0 wt % sulfonic acid-functional monomers, each based on a total weight of the mixture of ethylenically unsaturated monomers,
wherein a sum of the carboxylic acid-functional monomers and the sulfonic acid-functional monomers is 2.5 wt % to 3.5 wt %, based on a total weight of the mixture of ethylenically unsaturated monomers.

20. A polymer comprising:
125 to 250 μmol carboxylic acid units per gram of the polymer,
45 to 90 μmol sulfonic acid units per gram of the polymer, and
a total amount of carboxylic acid units and sulfonic acid units of 200 to 300 μmol per gram of the polymer.
